(19) United States
(12) Patent Application Publication
(10) Pub. No.: US 2021/0278243 A1
(43) Pub. Date: Sep. 9, 2021

(54) AREA DETERMINATION DEVICE, MAP DATA PROCESSING DEVICE, AND MAP DATA PROCESSING METHOD

(71) Applicant: MITSUBISHI ELECTRIC CORPORATION, Tokyo (JP)

(72) Inventor: Akihiro MIMURA, Tokyo (JP)

(73) Assignee: MITSUBISHI ELECTRIC CORPORATION, Tokyo (JP)

(21) Appl. No.: 16/479,346

(22) PCT Filed: Apr. 18, 2017
(86) PCT No.: PCT/JP2017/015593

§ 371 Date: Jul. 19, 2019

(51) Int. Cl. G01C 21/00; G01C 21/36

(52) U.S. Cl. CPC G01C 21/3889; G01C 21/3815; G01C 21/367

(57) ABSTRACT

It is an object of the present invention to perform the same processing in an area determination for a link group consisting of links connecting the same two points. An area determination device includes a map data acquisition unit for acquiring map data including a plurality of link data each representing a link connecting two points on a road map, an area specification unit for specifying any area on the road map, and an area determination unit for performing an area determination on whether the link is an intra-area link which is included in a specified area or an extra-area link which is not included in the specified area, collectively in a link group consisting of links each connecting the same two points as the link does, and the link data are processed in accordance with a result of the area determination.

### TECHNICAL FIELD

The present invention relates to an area determination device, a map data processing device, and a map data processing method.

### BACKGROUND ART

Patent Document 1 discloses a navigation device in which when a detour area is specified, by extracting a link across the detour area, appending detour increment data to the link, and calculating a route cost by using the detour increment data, a route detouring the detour area can be searched for. In the navigation device, since only the link across the detour area is extracted among a large number of links at least some of which are included in the detour area and the detour increment data is appended thereto, it is possible to suppress the number of appended data.

### PRIOR ART DOCUMENTS

### Patent Documents

[Patent Document 1] Japanese Patent Application Laid Open Gazette No. 2002-323335

### SUMMARY

### Problem to be Solved by the Invention

The above-described specification of a detour area is an exemplary processing accompanied by an area determination on map data. Thus, in the determination on whether or not a link is included in the specified area, it is preferable that the same determination should be made on a link group consisting of links between the same two points. The link group consisting of the links between the same two points includes, for example, links on different lanes on a road between the same two points, up and down links, and the like.

In the navigation device disclosed in Patent Document 1, however, when there is a boundary of the detour area between links A and B representing roads between the same two points, for example, the link B is determined to be inside the detour area and the link A is determined to be outside the detour area, and then a route search avoiding only the link B is disadvantageously performed. As a result, there arises a problem that it is determined not to detour a road where the detour area overlaps a lane link that is part of the road or it is determined not to detour a road on the down, which is detoured on the up.

The present invention is intended to solve such a problem as above, and it is an object of the present invention to perform an area determination in which the same determination is made on links between the same two points in a determination on whether the links are included in a specified area or not.

### Means to Solve the Problem

The present invention is intended for an area determination device. According to the present invention, the area determination device includes a map data acquisition unit for acquiring map data including a plurality of link data each representing a link connecting two points on a road map, an area specification unit for specifying an area on the road map as a specified area, and an area determination unit for performing an area determination on whether the link is an intra-area link which is included in the specified area or an extra-area link which is not included in the specified area, collectively in a link group consisting of links each connecting the same two points as the link does, and in the area determination device of the present invention, the link data are processed in accordance with a result of the area determination.

### Effects of the Invention

The area determination device according to the present invention includes a map data acquisition unit for acquiring map data including a plurality of link data each representing a link connecting two points on a road map, an area specification unit for specifying an area on the road map as a specified area, and an area determination unit for performing an area determination on whether the link is an intra-area link which is included in the specified area or an extra-area link which is not included in the specified area, collectively in a link group consisting of links each connecting the same two points as the link does, and in the area determination device, the link data are processed in accordance with a result of the area determination. Therefore, in the area determination device according to the present invention, in a determination on whether or not the link is included in the specified area, an area determination in which the same determination is made on the links between the same two points can be performed.

These and other objects, features, aspects and advantages of the present invention will become more apparent from the following detailed description of the present invention when taken in conjunction with the accompanying drawings.

### BRIEF DESCRIPTION OF DRAWINGS

FIG. 1 is a block diagram showing a constitution of an area determination device in accordance with a first preferred embodiment;

FIG. 2 is a view showing an exemplary road;

FIG. 3 is a view representing the road of FIG. 2 by links on a road basis;

FIG. 4 is a view representing the road of FIG. 2 by links on a lane basis;

FIG. 5 is a flowchart showing an operation of the area determination device in accordance with the first preferred embodiment;

FIG. 6 is a block diagram showing a constitution of a route search device in accordance with a second preferred embodiment;

FIG. 7 is a flowchart showing an operation of an area determination device in accordance with the second preferred embodiment;

FIG. 8 is a view showing a search route in a comparative example;

FIG. 9 is a view showing a search route in the comparative example;

FIG. 10 is a view showing a search route in the comparative example;

FIG. 11 is a view showing a search route in accordance with the second preferred embodiment;

FIG. 12 is a view showing a search route in accordance with the second preferred embodiment;

FIG. 13 is a view showing a search route in accordance with the second preferred embodiment;

FIG. 14 is a block diagram showing a constitution of a route search device in accordance with a third preferred embodiment;

FIG. 15 is a flowchart showing an operation of an area determination device in accordance with the third preferred embodiment;

FIG. 16 is a view showing a search route in accordance with the third preferred embodiment;

FIG. 17 is a view showing a search route in accordance with the third preferred embodiment;

FIG. 18 is a view showing a search route in accordance with the third preferred embodiment;

FIG. 19 is a view showing a hardware constitution of an area determination device or a route search device in accordance with the present invention;

FIG. 20 is a view showing another hardware constitution of the area determination device or the route search device in accordance with the present invention; and

FIG. 21 is a view showing a constitution of the route search device constituted of an in-vehicle device and a server in accordance with the second preferred embodiment.

### DESCRIPTION OF EMBODIMENT(S)

<A. The First Preferred Embodiment>

FIG. 1 is a block diagram showing a constitution of an area determination device 101 in accordance with the first preferred embodiment. The area determination device 101 performs an area determination on whether a link on a road map is an “intra-area link” which is included in a specified area on the road map or an “extra-area link” which is not included therein. The area determination device 101 is implemented as, for example, a navigation device mounted on a vehicle.

The area determination device 101 comprises a map data acquisition unit 11, an area specification unit 12, and an area determination unit 13. Then, the area determination device 101 is connected to a map data memory unit 21 and can use it.

The map data memory unit 21 stores therein map data. In the present preferred embodiment, description will be made on a case where the map data stored in the map data memory unit 21 include map data on a road basis and map data on a lane basis. The map data memory unit 21, however, may include either one of these map data. These map data each have a plurality of link data. The link data are data representing a link connecting two points on the road map.

The map data acquisition unit 11 acquires the map data from the map data memory unit 21.

The area specification unit 12 specifies any area from a geographical range represented by the map data acquired by the map data acquisition unit 11, as a specified area.

The area determination unit 13 performs an area determination on whether each link included in the map data is an intra-area link which is included in the specified area or an extra-area link which is not included in the specified area. In principle, the area determination unit 13 determines a link overlapping the specified area as the intra-area link and determines a link not overlapping the specified area as the extra-area link. When there are a link overlapping the specified area and another link not overlapping the specified area among a link group consisting of links connecting the same two points on the map, however, the area determination unit 13 determines all the links in the link group as the intra-area links or the extra-area links.

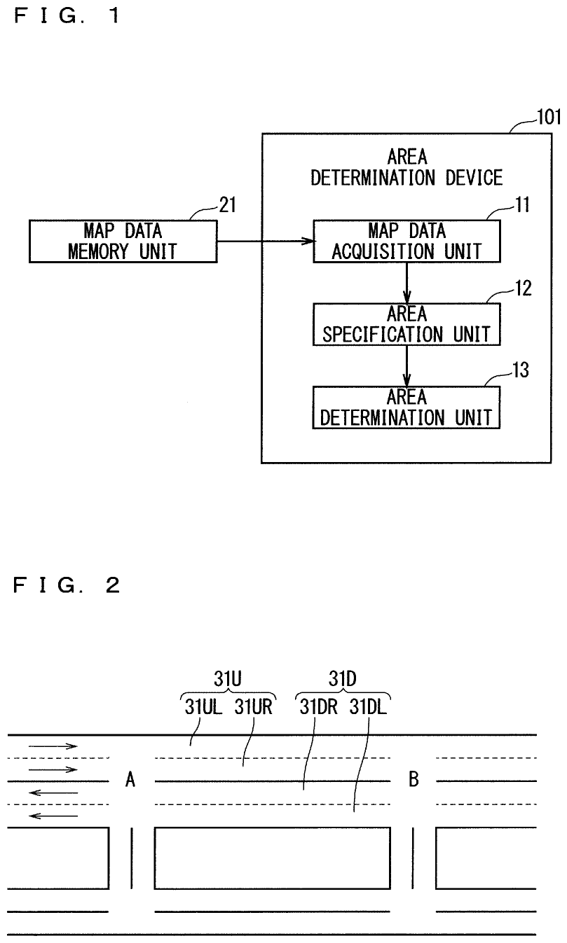

FIG. 2 is a view showing an example of an actual road. In FIG. 2, points A and B are connected to each other with an up-line road 31U and a down-line road 31D. Then, the road 31U consists of a left-side lane 31UL and a right-side lane 31UR, and the road 31D consists of a left-side lane 31DL and a right-side lane 31DR. In other words, the lanes 31UL, 31UR, 31DL, and 31DR are each a road connecting the same two points A and B.

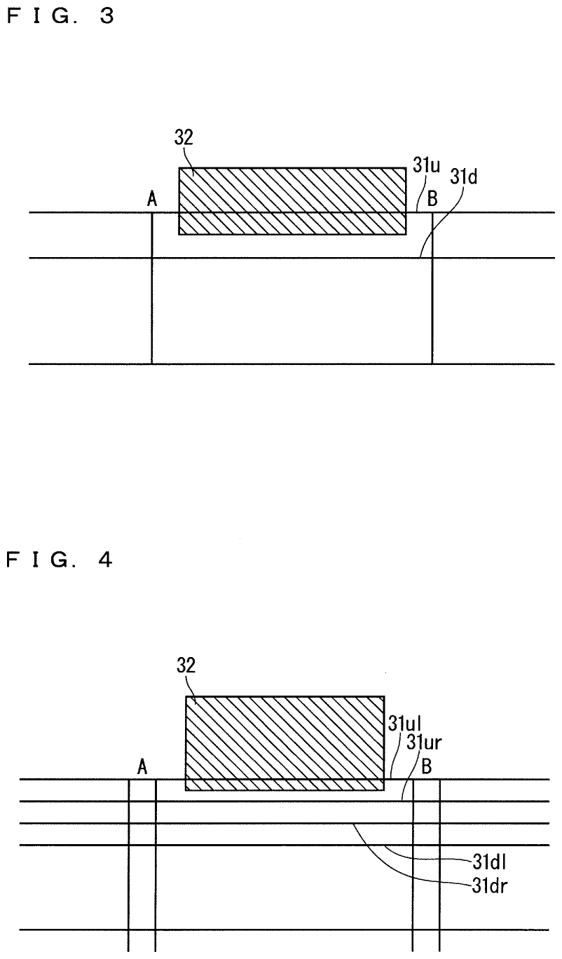

FIG. 3 is a view representing the road of FIG. 2 by links on a road basis. The map data acquisition unit 11 acquires the map data including data of these links. The lanes 31UL and 31UR of the road 31U are collectively represented by a link 31u, and the lanes 31DL and 31DR of the road 31D are collectively represented by a link 31d. Herein, the links 31u and 31d are links connecting the same two points A and B on the road map and belong to the one link group. Further, the link is represented on a road basis herein, and there is no link corresponding to each of the lanes 31UL, 31UR, 31DL, and 31DR.

FIG. 4 is a view representing the road of FIG. 2 by links on a lane basis. The map data acquisition unit 11 acquires the map data including data of these links. Specifically, the map data acquired by the map data acquisition unit 11 include link data on a road basis and link data on a lane basis. The lanes 31UL, 31UR, 31DL, and 31DR are represented by 31ul, 31ur, 31dl, and 331dr, respectively. Herein, the links 31ul, 31ur, 31dl, and 31dr are links connecting the same two points A and B on the road map and belong to the one link group.

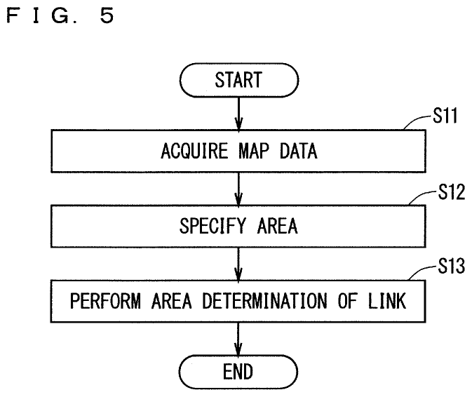

FIG. 5 is a flowchart showing an operation of the area determination device 101. Hereinafter, along FIG. 5, the operation of the area determination device 101 will be described. First, the map data acquisition unit 11 acquires the map data from the map data memory unit 21 (Step S11). This map data include the data of the links shown in FIGS. 3 and 4.

Next, the area specification unit 12 specifies any area from a geographical range represented by the map data acquired in Step S11 (Step S12). For example, the area specification unit 12 specifies a specified area 32 shown in FIG. 3 or 4.

Next, the area determination unit 13 performs an area determination of the links included in the map data, i.e., a determination on whether the link is the intra-area link which is included in the specified area or the extra-area link which is not included in the specified area (Step S13).

In the exemplary case shown in FIG. 3, among the link group consisting of the links connecting the points A and B, the link 31u overlaps the specified area 32 but the link 31d does not overlap the specified area 32. Thus, when there are a link overlapping the specified area and another link not overlapping the specified area among one link group, the area determination unit 13 determines the links 31u and 31d belonging to the same link group, collectively as the intra-area links or the extra-area links. When both the links 31u and 31d overlap the specified area 32, the area determination unit 13 determines both the links 31u and 31d as the intra-area links, and when neither of the links 31u and 31d overlaps the specified area 32, the area determination unit 13 determines both the links 31u and 31d as the extra-area links.

In the exemplary case shown in FIG. 4, among the link group consisting of the links connecting the points A and B, the link 31ul overlaps the specified area 32 but the links 31ur, 31dr, and 31dl do not overlap the specified area 32. Thus, when there are a link overlapping the specified area and another link not overlapping the specified area among one link group, the area determination unit 13 determines the links 31ul, 31ur, 31dr, and 31dl, collectively as the intra-area links or the extra-area links. Though FIG. 4 exemplarily shows a case where only the link 31ul overlaps the specified area 32 among the link group consisting of the links connecting the points A and B, when even some of the links 31ul, 31ur, 31dr, and 31dl overlap the specified area 32, the area determination unit 13 determines the links 31ul, 31ur, 31dr, and 31dl, collectively as the intra-area links or the extra-area links. Further, when all the links 31ul, 31ur, 31dr, and 31dl overlap the specified area 32, the area determination unit 13 determines all these links as the intra-area links, and when none of the links 31ul, 31ur, 31dr, and 31dl overlaps the specified area 32, the area determination unit 13 determines all these links as the extra-area links.

As described above, the area determination device 101 of the first preferred embodiment comprises the map data acquisition unit 11, the area specification unit 12, and the area determination unit 13. The map data acquisition unit 11 acquires the map data. This map data include a plurality of link data, and each piece of link data represents a link connecting two points on the road map. The area specification unit 12 specifies any area on the road map as the specified area. The area determination unit 13 performs the area determination on whether the link is the intra-area link which is included in the specified area or the extra-area link which is not included in the specified area, collectively in a link group consisting of the links connecting the same two points as the above link does. Then, the link data is processed in accordance with the result of the area determination. Therefore, since the intra-area link and the extra-area link are not mixed in the link group consisting of the links connecting the same two points, the same determination can be made in the area determination.

<B. The Second Preferred Embodiment>

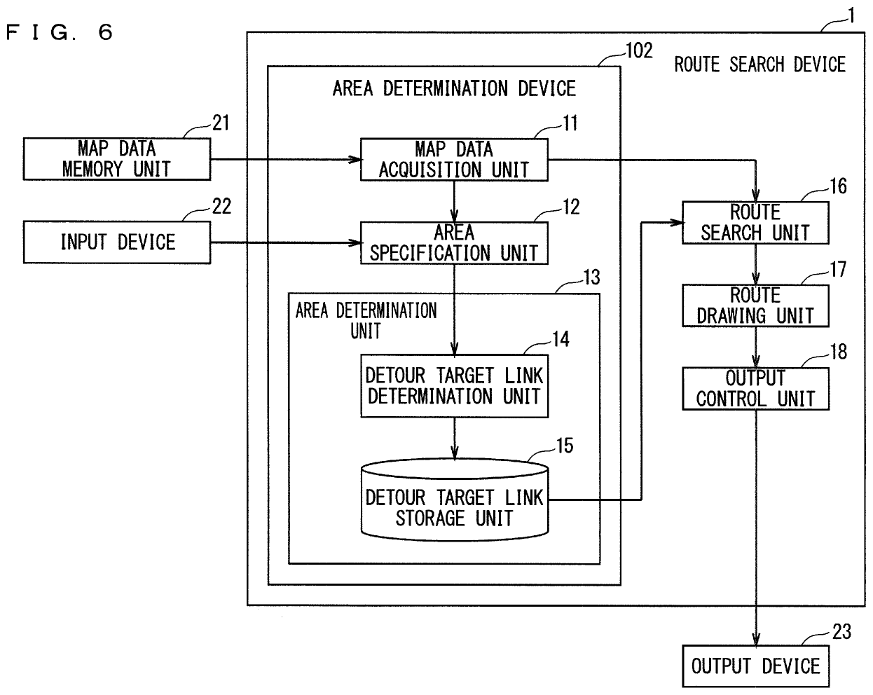

FIG. 6 is a block diagram showing a constitution of a route search device 1 in accordance with the second preferred embodiment of the present invention. The route search device 1 comprises an area determination device 102, a route search unit 16, a route drawing unit 17, and an output control unit 18. The route search unit 16, the route drawing unit 17, and the output control unit 18 are processing units for processing the link data in accordance with a determination result of the area determination device 102.

The area determination device 102 has a constitution in which the area determination unit 13 in the area determination device 101 of the first preferred embodiment comprises a detour target link determination unit 14 and a detour target link storage unit 15. The area determination device 102 is connected to the map data memory unit 21 and an input device 22, and can use these constituent elements.

The map data acquisition unit 11 acquires necessary map data form the map data memory unit 21, for example, through the map API (Application Programming Interface) or communication.

The input device 22 is a device for user's input operation on the area determination device 102, and is, for example, a remote control or a touch switch provided in a liquid crystal display.

The area specification unit 12 acquires operation information of the user from the input device 22 and determines a specified area on the basis of the user's operation information.

Further, the route search device 1 is connected to an output device 23, and can use the device.

The operation of the area specification unit 12 is the same as described in the first preferred embodiment. In the second preferred embodiment, the specified area of the area specification unit 12 is referred to as a “detour area”.

The detour target link determination unit 14 performs an operation similar to that of the area determination unit 13 in the first preferred embodiment. Specifically, the detour target link determination unit 14 determines whether the link of the map data acquired by the map data acquisition unit 11 is an intra-area link which is included in the detour area or an extra-area link which is not included in the detour area. Further, in the present preferred embodiment, the intra-area link will be referred to as a “detour target link”, and the extra-area link will be referred to as a “detour nontarget link”.

The detour target link storage unit 15 stores therein the link data of the detour target link.

The route search unit 16 performs a route search by using the map data acquired by the map data acquisition unit 11. Herein, the route search unit 16 performs different processings on the detour target link and the detour nontarget link, respectively. Specifically, the route search unit 16 performs the route search by using only the detour nontarget link, excluding the detour target link. A search route of the route search unit 16 is thereby constituted of only the detour nontarget links and is a route not going through the detour area.

Further, using only the detour nontarget link is one exemplary method for performing different processings on the detour target link and the detour nontarget link for the route search, and the route search unit 16 may also perform another method of adding an additional cost to the detour target link and then performing a route search by using both the detour target link and the detour nontarget link. In this case, if the conditions other than the additional cost are the same, the detour target link has a cost higher than that of the detour nontarget link by the additional cost and consequently, the detour nontarget link is preferentially searched out. As a result, the route search unit 16 searches for a route going through the detour area as little as possible.

The route drawing unit 17 creates a guide screen of the route searched out by the route search unit 16.

The output control unit 18 controls the output device 23 to display thereon the guide screen created by the route drawing unit 17. In other words, the output control unit 18 causes the output device 23 to output information of the route searched out by the route search unit 16.

The output device 23 is a display device such as a liquid crystal display or the like.

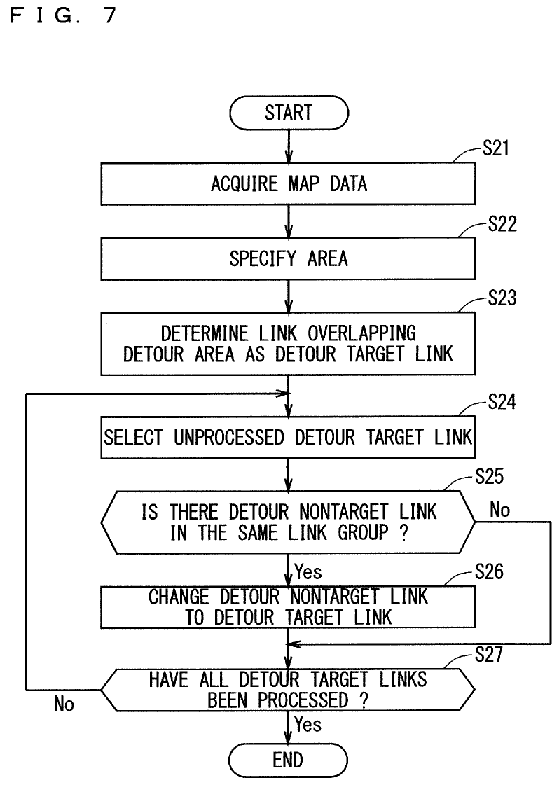

FIG. 7 is a flowchart showing an operation of the area determination device 102. Hereinafter, along the flowchart of FIG. 7, the operation of the area determination device 102 will be described. Since Steps S21 and S22 in the flow of FIG. 7 are the same as Steps S11 and S12 of FIG. 5 described in the first preferred embodiment, however, description thereof will be omitted.

The detour target link determination unit 14 determines a link overlapping the detour area, among the links whose link data are included in the map data acquired in

Step S21, as the detour target link (Step S23). At that time, the detour target link determination unit 14 stores the link data of the link determined as the detour target link into the detour target link storage unit 15. Further, in this stage, the detour target link determination unit 14 determines a link not overlapping the detour area as the detour nontarget link.

Next, the detour target link determination unit 14 selects the detour target link on which operations in Steps S25 and S26 described later are not performed (Step S24).

Then, the detour target link determination unit 14 determines whether there is a detour nontarget link or not in a link group consisting of the links connecting the same two points as the detour target link selected in Step S24 does, i.e., in the same link group (Step S25). In this step, if there is a link whose link data is not stored in the detour target link storage unit 15 among the other links in the same link group, “Yes”, and if there is not, “No”.

Herein, the same link group refers to, for example, a link group representing different lanes on a road between the same two points, or a link group representing the up and down on a road between the same two points. In the exemplary case shown in FIG. 3, the links 31d and 31u belong to the same link group, and in the exemplary case shown in FIG. 4, the links 31ul, 31ur, 31dr, and 31dl belong to the same link group.

In Step S25, if there is no detour nontarget link in the same link group, the operation of the area determination device 102 goes to Step S27. On the other hand, if there is a detour nontarget link in the same link group in Step S25, the detour target link determination unit 14 changes the detour nontarget link to the detour target link (Step S26). Herein, the detour target link determination unit 14 stores the link data of the link determined as the detour target link into the detour target link storage unit 15.

Next, the detour target link determination unit 14 determines whether or not all the detour target links have been subjected to the process of referring to the other links in the same link group described in Steps S25 and S26 (Step S27). If there is an unprocessed detour target link, the operation of the area determination device 102 goes back to Step S24. On the other hand, if the process of referring to the other links in the same link group has completed for all the detour target links, the operation of the area determination device 102 is ended.

With the above operation, if there is a link overlapping the detour area among the link group consisting of the links connecting the same two points, the area determination device 102 determines all the links in the link group as the detour target links. Thus, by performing the area determination collectively in the same link group, it is possible to prevent a difference from arising in the determination on whether the link is included or not in the detour area among the same link group.

Further, the above description has been made on the case where the area determination unit 13 performs the area determination of the links collectively in a link group consisting of the links connecting the same two points. The area determination unit 13, however, may selectively perform the area determination of the links collectively on a link group basis or on a link basis in accordance with, for example, the scale of the road map. Specifically, on a large-scale wide area map, by performing the area determination collectively in a link group consisting of the links connecting the same two points, the same determination may be made on all the links in the same link group. Then, on a small-scale detailed map, the area determination may be performed on a link basis.

Next, description will be made on the subsequent processing on the links after being subjected to the area determination.

The route search unit 16 acquires the map data from the map data acquisition unit 11 and performs a route search. At that time, the route search unit 16 acquires the link data of the detour target links from the detour target link storage unit 15, and performs the route search by using only the detour nontarget links, excluding the detour target links. Therefore, the search route of the route search unit 16 is constituted of only the detour nontarget links.

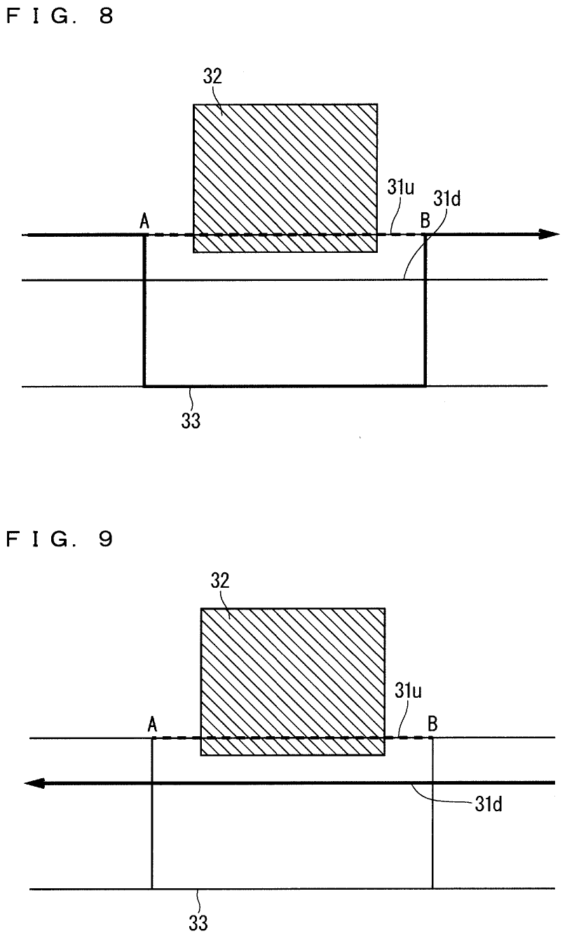

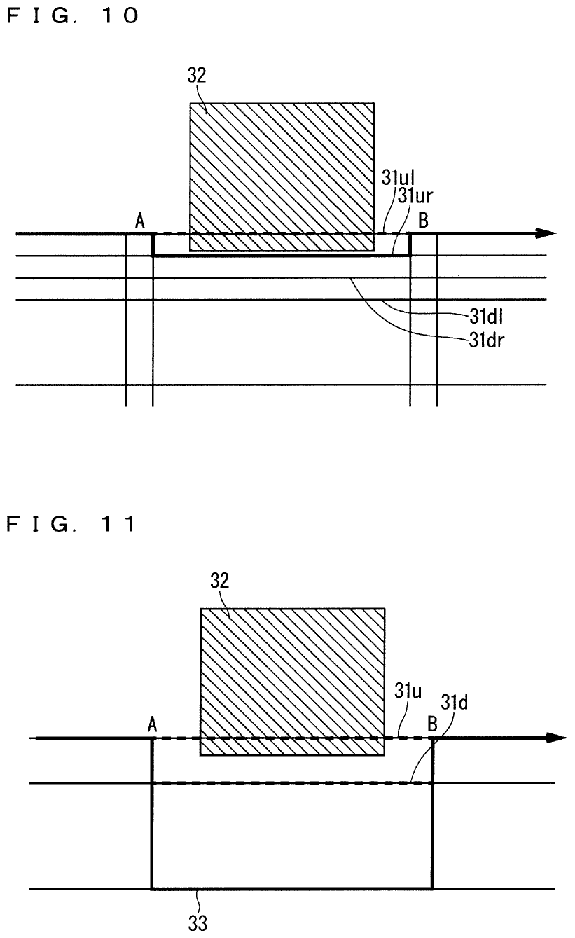

FIGS. 8 to 10 each show a search route in a comparative example. FIGS. 8 and 9 each show a search route in the links on a road basis shown in FIG. 3, and FIG. 10 shows a search route in the links on a lane basis shown in FIG. 4.

In FIGS. 8 and 9, the road connecting the points A and B is constituted of the up link 31u and the down link 31d, and only the link 31u overlaps the specified area 32 (detour area). Herein, unlike in the present preferred embodiment, it is assumed that the link 31u is the detour target link and the link 31d in the same link group as the link 31u is the detour nontarget link. A link 33 is also a detour nontarget link. In FIGS. 8 and 9, the link 31u which is the detour target link is indicated by the dotted line.

In this case, in a route search between the points A and B, a route following the link 33, avoiding the link 31u, is searched out on the up as shown in FIG. 8, and a route following the link 31d is searched out on the down as shown in FIG. 9. Thus, despite the same road connecting the points A and B, there arises a difference in whether to detour between the up and the down.

FIG. 10 is a view showing a link shape on a lane basis, representing the road shown in FIG. 2. The road connecting the points A and B is constituted of the up links 31ul and 31ur and the down links 31dl and 31dr. Among the links 31ul, 31ur, 31dl, and 31dr, only the link 31ul overlaps the specified area 32 (detour area). Herein, unlike in the present invention, it is assumed that the link 31ul is the detour target link and the links 31ur, 31dl, and 31dr in the same link group as the link 31ul are the detour nontarget links. In FIG. 10, the link 31ul which is the detour target link is indicated by the dotted line.

In this case, in the route search on the up between the points A and B, a route following the link 31ur, avoiding the link 31ul, is searched out. Thus, though the detour area overlapping the link 31ul is specified, since the link 31ur which is on the different lane from the link 31ul on the same road is the detour nontarget link, as a result, the route following the same road as the link 31ul is disadvantageously searched out, instead of detouring the road.

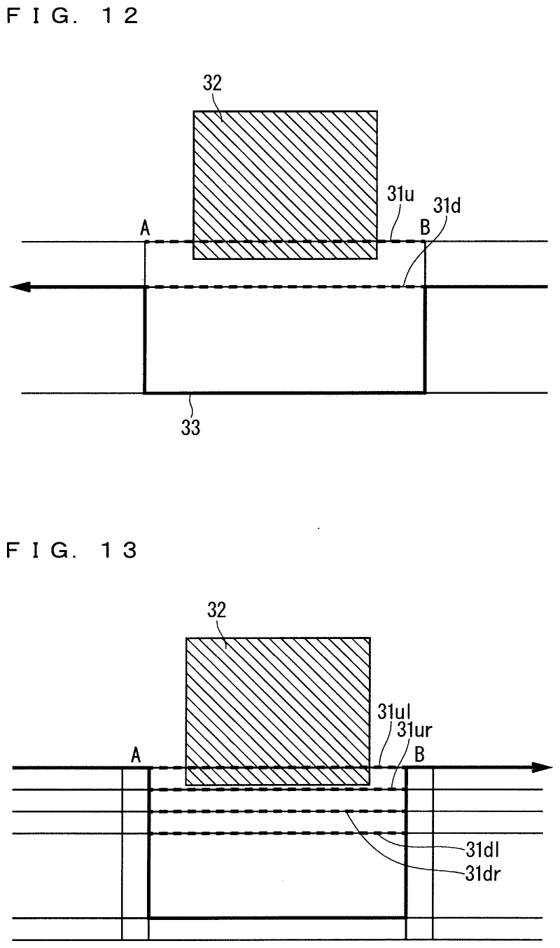

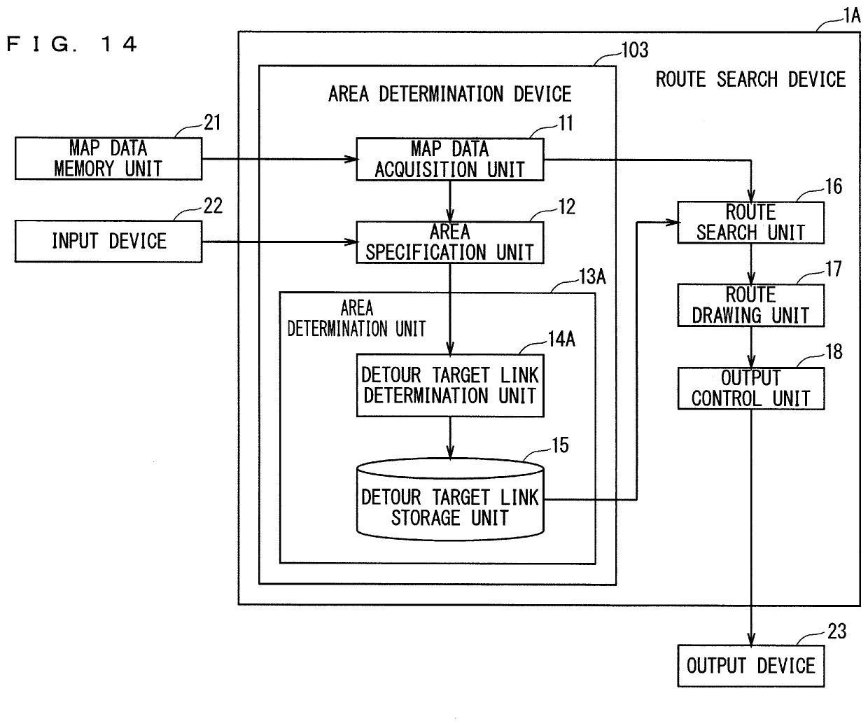

In the present preferred embodiment, however, when even one link overlaps the detour area among the link group consisting of the links connecting the same two points, all the links in the link group are determined as the detour target links, and therefore the above-described problem can be solved. FIGS. 11 and 12 are views each showing a search route in the present preferred embodiment in the situation corresponding to that in FIG. 8, and FIG. 13 is a view showing a search route in the present preferred embodiment in the situation corresponding to that in FIG. 10.

As shown in FIGS. 11 and 12, in the area determination device 102, both the up link 31u and the down link 31d constituting the same road are determined as the detour target links. In the route search between the points A and B, the route search unit 16 searches out a route avoiding the link 31u on the up as shown in FIG. 11 and avoiding the link 31d on the down as shown in FIG. 12. Thus, when only one of the up and the down of the road overlaps the detour area, by determining both the up and down links as the detour target links, it is possible to perform uniform processing on whether to detour the road.

Further, as shown in FIG. 13, in the area determination device 102, all the links 31ul, 31ur, 31dr, and 31dl on the different lanes constituting the same road are determined as the detour target links. In the route search between the points A and B, the route search unit 16 searches out a route avoiding the links 31ul, 31ur, 31dr, and 31dl. Thus, when only some of the lanes overlap the detour area on the road constituted of a plurality of lanes, by determining the links of all the lanes as the detour target links, it is possible to perform uniform processing for all the lanes on whether to detour the road.

<C. The Third Preferred Embodiment>

FIG. 14 is a block diagram showing a constitution of a route search device 1A in accordance with the third preferred embodiment of the present invention. The route search device 1A has a constitution in which an area determination device 103 is provided, instead of the area determination device 102, in the constitution of the route search device 1 of the second preferred embodiment. The area determination device 103 has a constitution in which an area determination unit 13A is provided, instead of the area determination unit 13, in the constitution of the area determination device 102 of the second preferred embodiment.

The area determination unit 13A comprises a detour target link determination unit 14A and the detour target link storage unit 15.

When there is a link overlapping the detour area among the link group consisting of the links connecting the same two points, the area determination unit 13 of the second preferred embodiment determines all the links in the link group as the detour target links. On the other hand, when there is a link not overlapping the detour area among the link group consisting of the links connecting the same two points, the area determination unit 13A of the third preferred embodiment determines all the links in the link group as the detour nontarget links.

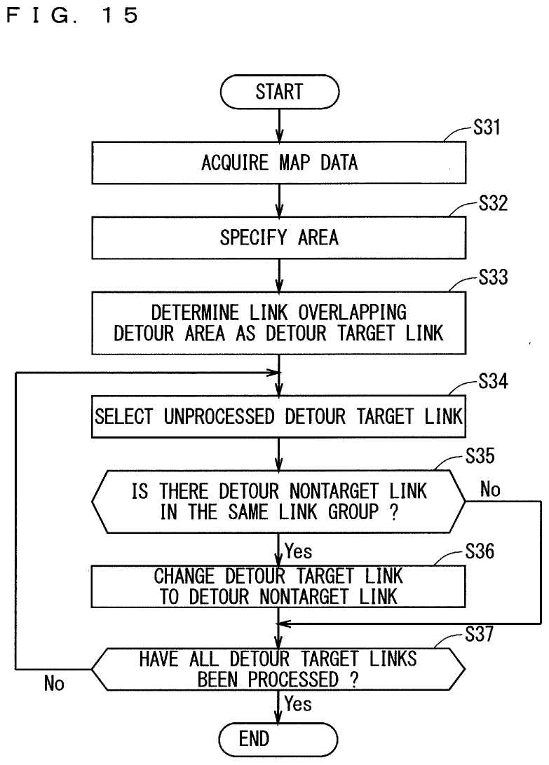

FIG. 15 is a flowchart showing an operation of the area determination device 103. Hereinafter, along the flowchart of FIG. 15, the operation of the area determination device 103 will be described. Since Steps S31 to S35 in the flow of FIG. 15 are the same as Steps S21 to S25 of FIG. 7 described in the second preferred embodiment, however, description thereof will be omitted.

The detour target link determination unit 14A determines whether there is a detour nontarget link or not in a link group consisting of the links connecting the same two points as the detour target link selected in Step S34 does, i.e., in the same link group (Step S35). In this step, if there is a link whose link data is not stored in the detour target link storage unit 15 among the other links in the same link group, “Yes”, and if there is not, “No”.

In Step S35, if there is no detour nontarget link in the same link group, the operation of the area determination device 103 goes to Step S37. On the other hand, if there is a detour nontarget link in the same link group in Step S35, the detour target link determination unit 14A changes all the detour target links to the detour nontarget links (Step S36). Herein, the detour target link determination unit 14A stores the link data of the link determined as the detour target link into the detour target link storage unit 15. Thus, when there is a link not overlapping the detour area in the link group, the detour target link determination unit 14A determines all the links in the link group as the extra-area link.

Next, the detour target link determination unit 14A determines whether or not all the detour target links have been subjected to the process of referring to the other links in the same link group, which is described in Steps S35 and S36 (Step S37). If there is an unprocessed detour target link, the operation of the area determination device 103 goes back to Step S34. On the other hand, if the process of referring to the other links in the same link group has completed for all the detour target links, the operation of the area determination device 103 is ended.

Next, description will be made on the subsequent processing on the links after being subjected to the area determination in the area determination unit 13A. The route search unit 16 acquires the map data from the map data acquisition unit 11 and performs a route search. At that time, the route search unit 16 acquires the link data of the detour target links from the detour target link storage unit 15, and performs the route search by using only the detour nontarget links, excluding the detour target links. Therefore, the search route of the route search unit 16 is constituted of only the detour nontarget links.

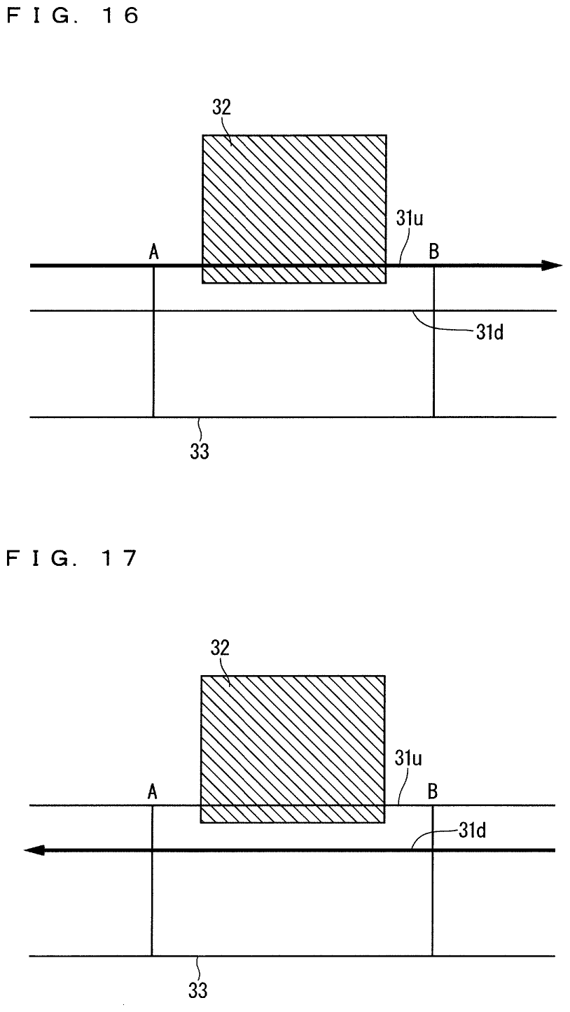

FIGS. 16 and 17 each show a route searched out by the route search unit 16 in the link shape on a road basis shown in FIG. 3. Among the up link 31u and the down link 31d between the points A and B, only the link 31u overlaps the specified area 32 (detour area). Since the area determination unit 13A, however, determines both the links 31u and 31d as the detour nontarget links, as shown in FIG. 16, the route search unit 16 searches out a route following the link 31u on the up and a route following the link 31d on the down. Thus, when only one of the up and the down of the road overlaps the detour area, by determining both the up and down links as the detour nontarget links, it is possible to perform the same determination on whether to detour.

FIG. 18 shows a route searched out by the route search unit 16 in the link shape on a lane basis shown in FIG. 4. Among the up links 31ul and 31ur and the down links 31dl and 31dr between the points A and B, only the link 31ul overlaps the specified area 32 (detour area). The area determination unit 13A determines all the links 31ul, 31ur, 31dr, and 31dl as the detour nontarget links. Therefore, the route search unit 16 can search out a route following the link 31ul overlapping the detour area between the points A and B. Thus, when only some of the lanes overlap the detour area on the road constituted of a plurality of lanes, by determining the links of all the lanes as the detour nontarget links, it is possible to perform uniform processing for all the lanes on whether to detour.

Though the case has been described in the second and third preferred embodiments, where the specified area in the area specification unit 12 is used for the route search as the “detour area”, the present area determination can be applied to other processings using the area determination, such as a display of the map or traffic information, a search, a display, or the like for a facility,

<D. Hardware Constitution>

The map data acquisition unit 11, the area specification unit 12, and the area determination units 13 and 13A in the above-described area determination devices 101, 102, and 103 and the route search unit 16, the route drawing unit 17, and the output control unit 18 in the route search devices 1 and 1 A are implemented by a processing circuit 81 shown in FIG. 19. Specifically, the processing circuit 81 comprises the map data acquisition unit 11, the area specification unit 12, the area determination units 13 and 13A, the route search unit 16, the route drawing unit 17, and the output control unit 18 (hereinafter, referred to as “the area determination unit 13 and the like”). To the processing circuit 81, a dedicated hardware may be applied, or a processor which executes a program stored in a memory may be applied. As the processor, for example, used is a central processing unit (CPU), a processing unit, an arithmetic unit, a microprocessor, a microcomputer, a digital signal processor (DSP), or the like.

When the processing circuit 81 is a dedicated hardware, the processing circuit 81 corresponds to, for example, a single circuit, a complex circuit, a programmed processor, a multiple programmed processor, an ASIC (Application Specific Integrated Circuit), an FPGA (Field Programmable Gate Array), or a combination of these circuits. Respective functions of the constituent elements such as the area determination unit 13 and the like may be implemented by a plurality of processing circuits 81, or these functions may be collectively implemented by one processing circuit.

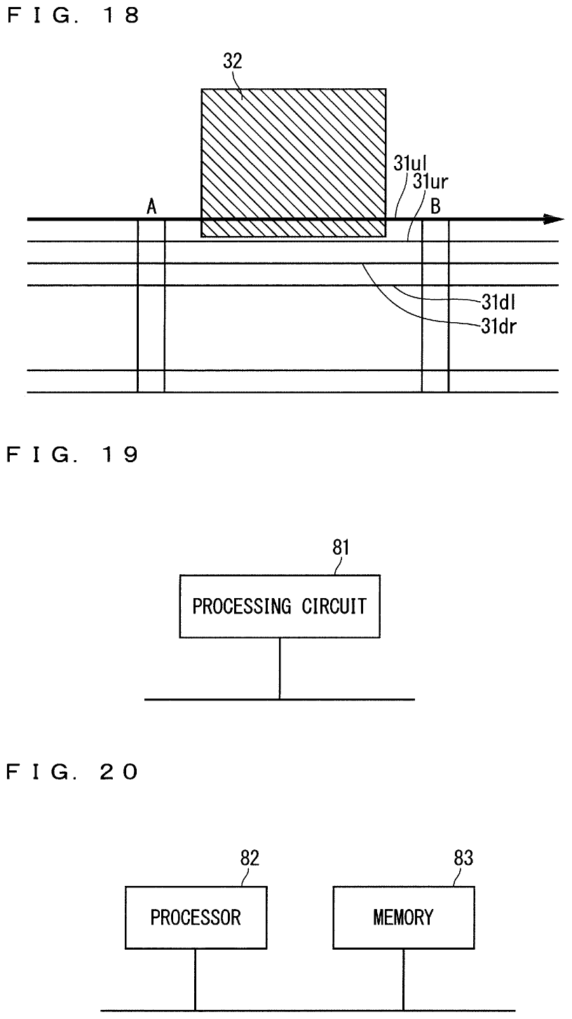

When the processing circuit 81 is a processor, the functions of the area determination unit 13 and the like are implemented by combination with software (software, firmware, or software and firmware) or the like. The software or the like is described as a program and stored in a memory. As shown in FIG. 20, a processor 82 applied to the processing circuit 81 reads and executes the program stored in a memory 83, to thereby implement the respective functions of the constituent elements. Specifically, the area determination device 101 comprises the memory 83 which stores therein programs which are executed by the processing circuit 81 to consequently perform the step of acquiring map data including a plurality of link data each representing a link connecting two points on a road map, the step of specifying any area on the road map as a specified area, the step of performing an area determination on whether the link is an intra-area link which is included in the specified area or an extra-area link which is not included in the specified area, collectively in a link group consisting of links each connecting the same two points, and the step of processing the link data in accordance with a result of the area determination. In other words, the program is executed to cause a computer to perform a procedure or a method of the area determination unit 13 and the like. Herein, the memory 83 may be, for example, a nonvolatile or volatile semiconductor memory such as a RAM (Random Access Memory), a ROM (Read Only Memory), a flash memory, an EPROM (Erasable Programmable Read Only Memory), an EEPROM (Electrically Erasable Programmable Read Only Memory), or the like, a HDD (Hard Disk Drive), a magnetic disk, a flexible disk, an optical disk, a compact disk, a mini disk, a DVD (Digital Versatile Disk) and a drive unit thereof or the like, or every storage medium to be used in the future.

The case has been described above where the respective functions of the area determination unit 13 and the like are implemented by one of hardware and software or the like. This is, however, only one exemplary case. There may be a case where some part of the area determination unit 13 and the like is implemented by a dedicated hardware and the other part is implemented by software or the like. For example, the function of the area determination unit 13 can be implemented by a processing circuit as the dedicated hardware and the respective functions of the other constituent elements can be implemented when the processing circuit 81 serving as the processor 82 reads out and executes the program stored in the memory 83.

Thus, the processing circuit 81 can implement the above-described functions by hardware, software or the like, or combination thereof. Further, the detour target link storage unit 15 is formed of the memory 83, and specifically may be formed of a single memory 83 or individual memories.

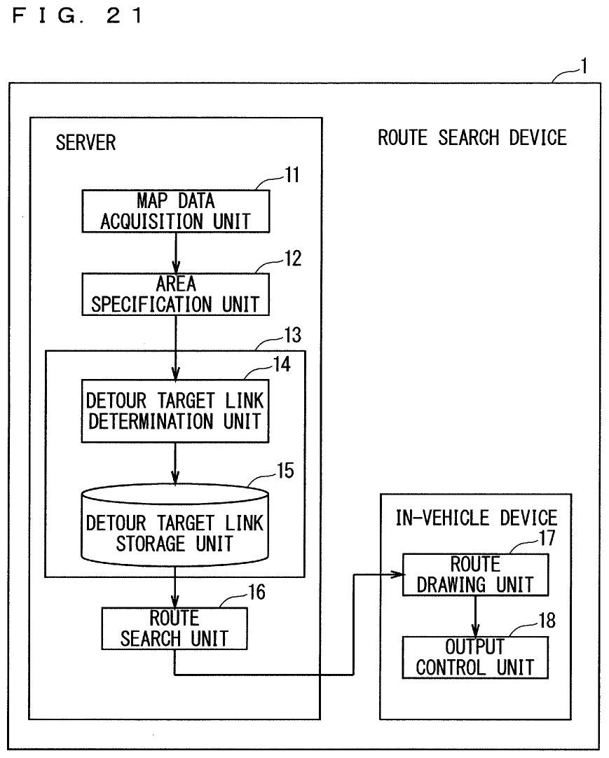

The route search devices 1 and 1A are each, for example, an in-vehicle device, but can be also applied to a system which is configured as a system by combining, as appropriate, an in-vehicle device, a PND (Portable Navigation Device), a communication terminal (e.g., a portable terminal such as a cellular phone, a smartphone, a tablet, or the like), a function of an application installed thereon, a server, and the like. In this case, the functions or the constituent elements of the route search devices 1 and 1A described above may be arranged dispersedly in these devices constituting the system or may be arranged collectively in any one device. As one example thereof, FIG. 21 shows an exemplary constitution of the route search device 1 constituted of a server and an in-vehicle device. Herein, the map data acquisition unit 11, the area specification unit 12, the area determination unit 13, and the route search unit 16 are formed of the server, and the route drawing unit 17 and the output control unit 18 are formed of the in-vehicle device.

In the present invention, the preferred embodiments and the variations may be freely combined, or may be changed or omitted as appropriate, without departing from the scope of the invention.

While the invention has been shown and described in detail, the foregoing description is in all aspects illustrative and not restrictive. It is therefore understood that numerous modifications and variations can be devised without departing from the scope of the invention.

### EXPLANATION OF REFERENCE SIGNS

1, 1A route search device, 11 map data acquisition unit, 12 area specification unit, 13, 13A area determination unit, 14, 14A detour target link determination unit, 15 detour target link storage unit, 16 route search unit, 17 route drawing unit, 18 output control unit, 21 map data memory unit, 22 input device, 23 output device, 32 specified area, 81 processing circuit, 82 processor, 83 memory, 101, 102, 103 area determination device

1. An area determination device, comprising:
a first processor to execute a first program; and
a first memory to store the first program which, when executed by the first processor, performs first processes of,
acquiring map data including a plurality of link data each representing a link connecting two points on a road map;
specifying an area on the road map as a specified area; and
performing an area determination on whether the link is an intra-area link which is included in the specified area or an extra-area link which is not included in the specified area, collectively in a link group consisting of links each connecting the same two points as the link does,
wherein the link data are processed in accordance with a result of the area determination.

2. The area determination device according to claim 1, wherein
when there is a link which overlaps the specified area among the link group, the first processes comprise determining all the links in the link group as the intra-area links.

3. The area determination device according to claim 1, wherein
when there is a link which does not overlap the specified area among the link group, the first processes comprise determining all the links in the link group as the extra-area links.

4. The area determination device according to claim 1, wherein
the link group includes links which connect the same two points and represent different lanes.

5. The area determination device according to claim 1, wherein
the link group includes an up link and a down link which connect the same two points.

6. The area determination device according to claim 1, wherein
the first processes comprise selecting whether to perform the area determination of the link collectively in a link group or by the link in accordance with a scale of the road map.

7. A map data processing device, comprising:
the area determination device according to claim 1,
a second processor to execute a second program; and
a second memory to store the second program which, when executed by the second processor, performs second processes of,
processing the link data in accordance with a determination result of the area determination unit.

8. The map data processing device according to claim 7, wherein
the second processes comprise searching a route using the extra-area link, excluding the intra-area link, and
causing an output device to output information of the searched route.

9. A map data processing method, comprising:
acquiring map data including a plurality of link data each representing a link connecting two points on a road map;
specifying an area on the road map as a specified area;
performing an area determination on whether the link is an intra-area link which is included in the specified area or an extra-area link which is not included in the specified area, collectively in a link group consisting of links each connecting the same two points; and
processing the link data in accordance with a result of the area determination.
